(19) United States
(12) Patent Application Publication
(10) Pub. No.: US 2025/0010901 A1
(43) Pub. Date: Jan. 9, 2025

(54) CART

(71) Applicant: MAKITA CORPORATION, Anjo-shi (JP)

(72) Inventors: Masahiro HARADA, Anjo-shi (JP); Tadasuke MATSUNO, Anjo-shi (JP); Kazuhiro YAMAKAWA, Anjo-shi (JP)

(73) Assignee: MAKITA CORPORATION, Anjo-shi (JP)

(21) Appl. No.: 18/760,771

(22) Filed: Jul. 1, 2024

(30) Foreign Application Priority Data
Jul. 3, 2023 (JP) 2023-109243

(51) Int. Cl. B62B 5/00; B62B 5/06

(52) U.S. Cl. CPC B62B 5/004; B62B 5/0069; B62B 5/06

(57) ABSTRACT

A cart may include a vehicle body; wheels supported by the vehicle body and configured to be in contact with a ground; a prime mover configured to drive the wheels; a handle configured to be gripped by a user walking behind the vehicle body; and a control unit configured to control an operation of the prime mover. When the cart performs a turning motion, as compared to a target vehicle speed for a turning motion in which a turning radius of the vehicle body is large, the control unit may be configured to set a slower target vehicle speed for a turning motion in which a turning radius of the vehicle body is small.

### REFERENCE TO RELATED APPLICATIONS

This application claims priority to Japanese Patent Application No. 2023-109243 filed on Jul. 3, 2023. The entire content of the priority application is incorporated herein by reference.

### TECHNICAL FIELD

The disclosure herein relates to a cart.

### BACKGROUND ART

Japanese Patent Application Publication No. 2000-78708 describes a cart. The cart includes a vehicle body, wheels supported by the vehicle body and configured to be in contact with a ground, a prime mover configured to drive the wheels, a handle configured to be gripped by a user walking behind the vehicle body, and a control unit configured to control an operation of the prime mover.

### SUMMARY

When a cart performs a turning motion, a user walking behind the vehicle body gripping the handle has to move faster than the vehicle body. In particular, with a smaller turning radius of the vehicle body, the user walking behind the vehicle body gripping the handle has to move even faster than the vehicle body. Therefore, the user may be pulled or swung by the turning motion of the cart. The disclosure herein provides a technology that suppresses a user from being pulled or swung when a cart performs a turning motion.

A cart disclosed herein may comprise a vehicle body; wheels supported by the vehicle body and configured to be in contact with a ground; a prime mover configured to drive the wheels; a handle configured to be gripped by a user walking behind the vehicle body; and a control unit configured to control an operation of the prime mover. When the cart performs a turning motion, as compared to a target vehicle speed for a turning motion in which a turning radius of the vehicle body is large, the control unit may be configured to set a slower target vehicle speed for a turning motion in which a turning radius of the vehicle body is small.

The configuration above allows the speed of the vehicle body to be slower for turning motion in which the turning radius of the vehicle body is smaller. This suppresses an increase in the user's speed when the cart performs turning motion. Thus, it is possible to suppress the user from being pulled or swung when the cart performs turning motion.

### BRIEF DESCRIPTION OF DRAWINGS

FIG. 1 shows a perspective view of a cart 2 according to an embodiment.

FIG. 2 shows a block diagram of the cart 2 according to the embodiment.

FIG. 3 shows a flowchart of a turning motion process by a control unit 52 of the cart 2 according to the embodiment.

FIG. 4 schematically shows a relationship between vehicle speed Vb and user speed Vu when the cart 2 performs a turning motion.

FIG. 5 shows a graph illustrating an exemplary relationship between turning motion curvature and vehicle speed of the cart 2 and user speed.

FIG. 6 shows a graph illustrating another exemplary relationship between turning motion curvature and vehicle speed of the cart 2 and user speed.

FIG. 7 shows a graph illustrating an exemplary relationship between a handle angle, a target vehicle speed, and its approximate function in the cart 2 according to the embodiment.

### DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved carts, as well as methods for using and manufacturing the same.

Moreover, combinations of features and steps disclosed in the following detailed description may not be necessary to practice the disclosure in the broadest sense, and are instead taught merely to particularly describe representative examples of the disclosure. furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, the cart may further comprise a steering mechanism configured to steer at least one of the wheels as a steered wheel.

A cart with the steering mechanism may be more likely to pull or swing a user when performing a turning motion, because it may perform the turning motion without reducing the vehicle speed sufficiently. The configuration above suppresses the user from being pulled or swung when the cart comprising the steering mechanism performs the turning motion.

In one or more embodiments, the handle may be supported by the vehicle body so as to be rotatable about a rotation axis and configured to be rotated by the user. The cart may further comprise a handle angle sensor configured to detect a rotation angle of the handle about the rotation axis as a handle angle. The control unit may be configured to set a target steering angle of the steered wheel for the turning motion based on the handle angle. The control unit may be configured to set the target vehicle speed for the turning motion based on the handle angle.

When the cart performs a turning motion according to rotation of the handle performed by the user, the larger the handle angle is, the smaller the turning radius of the vehicle body is, whereas the smaller the handle angle is, the larger the turning radius of the vehicle body is. The configuration above employs a simple structure that allows a slower target vehicle speed to be set for turning motion in which the turning radius of the vehicle body is small, as compared to the target vehicle speed for the turning motion in which the turning radius of the vehicle body is large.

In one or more embodiments, the control unit may be configured to calculate the target vehicle speed as a linear function of the handle angle.

The configuration above allows for a reduction in a processing load on the control unit.

In one or more embodiments, the prime mover may comprise a plurality of motors corresponding to the wheels, respectively.

The configuration above allows the vehicle speed to be easily adjusted when the cart performs a turning motion.

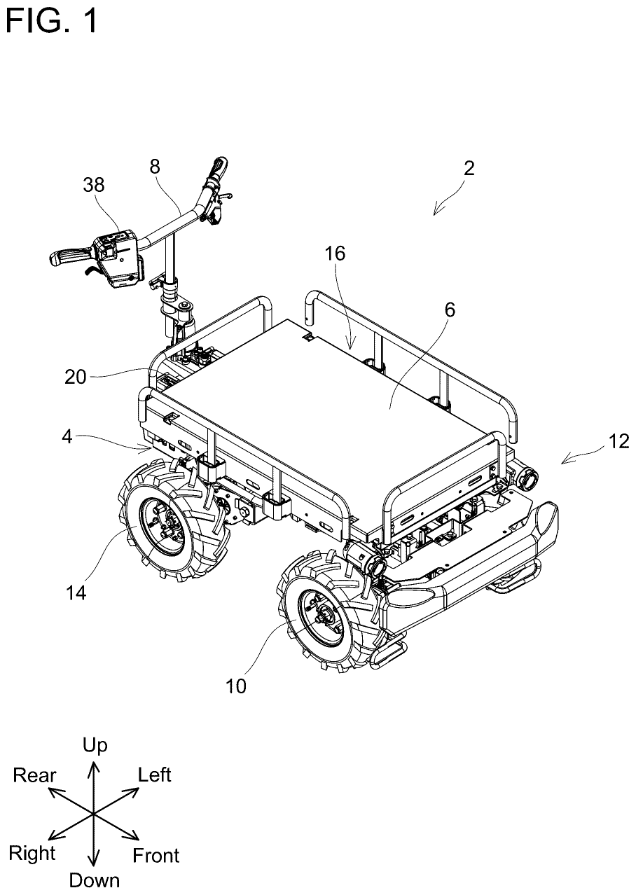

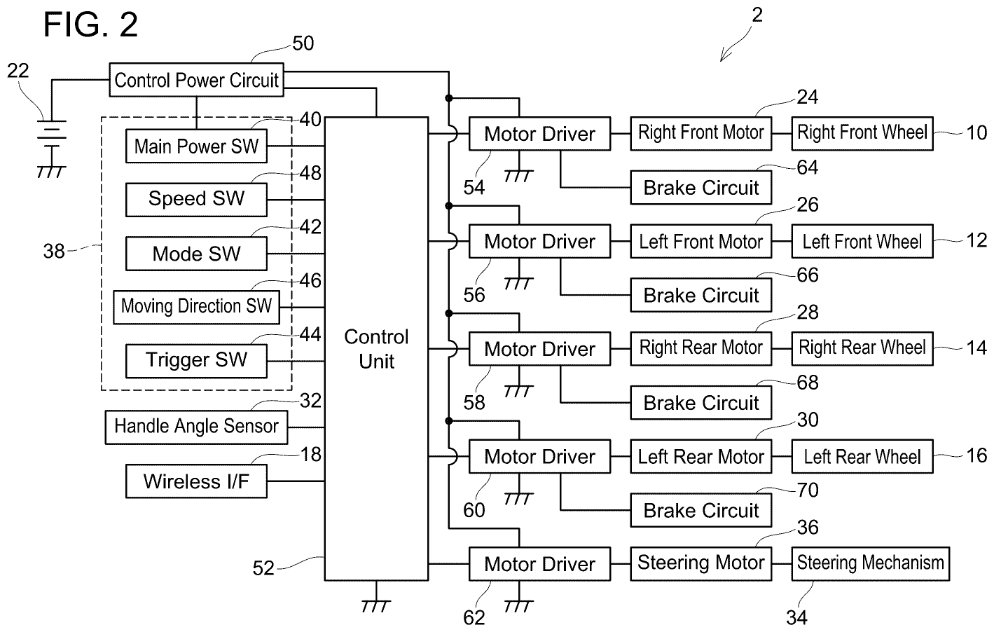

(Embodiment) A cart 2 shown in FIG. 1 comprises a vehicle body 4, a load-carrying platform 6, a handle 8, a right front wheel 10, a left front wheel 12, a right rear wheel 14, and a left rear wheel 16. The load-carrying platform 6, the handle 8, the right front wheel 10, the left front wheel 12, the right rear wheel 14, and the left rear wheel 16 are all supported by the vehicle body 4. The cart 2 carries a load on the load-carrying platform 6. The cart 2 comprises a wireless interface (I/F) 18 (see FIG. 2) mounted on the vehicle body 4. The cart 2 is configured to operate selectively in one of a manual mode, an autonomous mode, and a parking mode. In the manual mode, the cart 2 moves forward or rearward depending on the manipulation by a user standing behind the vehicle body 4 gripping the handle 8 with both hands. In the autonomous mode, the cart 2 performs a tracking operation in which the cart 2 follows a beacon (not shown) carried by the user standing in front of the vehicle body 4 and a remote-controlled operation in which the cart 2 moves according to instructions from a remote controller (not shown) operated by the user. In this mode, the cart 2 receives radio waves from the beacon and the remote controller via the wireless I/F 18. In the parking mode, the cart 2 remains stationary without accepting any instruction from the handle 8, the beacon, or the remote controller.

The cart 2 comprises a battery receptacle 20 on the vehicle body 4. The battery receptacle 20 is configured to allow a battery pack 22 (see FIG. 2) to be detachably attached thereto. The battery pack 22 comprises secondary battery cells (not shown) such as lithium ion battery cells and is configured to be recharged using a charger (not shown). The cart 2 operates with electric power supplied from the battery pack 22 attached to the battery receptacle 20.

As shown in FIG. 2, the cart 2 comprises a right front wheel motor 24 for driving the right front wheel 10, a left front wheel motor 26 for driving the left front wheel 12, a right rear wheel motor 28 for driving the right rear wheel 14, and a left rear wheel motor 30 for driving the left rear wheel 16. The right front wheel motor 24, the left front wheel motor 26, the right rear wheel motor 28, and the left rear wheel motor 30 are for example brushless motors. The right front wheel motor 24, the left front wheel motor 26, the right rear wheel motor 28, and the left rear wheel motor 30 are supported by the vehicle body 4.

As shown in FIG. 1, the handle 8 is rotatable relative to the vehicle body 4 about a rotation axis extending in an up-down direction. The user can rotate the handle 8 while gripping the handle 8 with both hands. As shown in FIG. 2, the cart 2 comprises a handle angle sensor 32 configured to detect a rotation angle of the handle 8 as a handle angle, a steering mechanism 34 configured to steer the right front wheel 10 and the left front wheel 12 as steered wheels, and a steering motor 36 configured to drive the steering mechanism 34. The steering motor 36 is for example a brushless motor. The handle angle sensor 32, the steering mechanism 34, and the steering motor 36 are supported by the vehicle body 4.

As shown in FIG. 1, a switch box 38 is located on the handle 8. As shown in FIG. 2, a main power switch 40, a mode switch 42, a trigger switch 44, a moving direction switch 46, and a speed switch 48 are located on the switch box 38. The main power switch 40 is for switching on/off of the main power of the cart 2. The mode switch 42 is for switching the operation mode of the cart 2 between the manual mode, the autonomous mode, and the parking mode. The trigger switch 44 is used in the manual mode to switch on/off of forward and rearward movements of the cart 2 and adjust the moving speed of the cart 2. The moving direction switch 46 is used in the manual mode to change the moving direction of the cart 2. The speed switch 48 is used in the manual mode to change the moving speed of the cart 2. The user can manipulate the main power switch 40, the mode switch 42, the trigger switch 44, the moving direction switch 46, and the speed switch 48 while gripping the handle 8 with both hands.

The cart 2 comprises a control power circuit 50 and a control unit 52. The control power circuit 50 permits the electric power to be supplied from the battery pack 22 in response to the main power switch 40 receiving an on-manipulation, while it prohibits the electric power from being supplied from the battery pack 22 in response to the main power switch 40 receiving an off-manipulation. The control unit 52 controls the cart 2. The control unit 52 controls the right front wheel motor 24, the left front wheel motor 26, the right rear wheel motor 28, the left rear wheel motor 30, and the steering motor 36 via motor drivers 54, 56, 58, 60, and 62, respectively. Brake circuits 64, 66, 68, and 70 are connected to the motor drivers 54, 56, 58, and 60, respectively, corresponding to the right front wheel motor 24, the left front wheel motor 26, the right rear wheel motor 28, and the left rear wheel motor 30. The control unit 52 can apply a large controlling force to the right front wheel motor 24, the left front wheel motor 26, the right rear wheel motor 28, and the left rear wheel motor 30 by flowing a large current through the brake circuits 64, 66, 68, and 70 during rotation of the right front wheel motor 24, the left front wheel motor 26, the right rear wheel motor 28, and the left rear wheel motor 30. The control power circuit 50, the control unit 52, the motor drivers 54, 56, 58, 60, 62, and the brake circuits 64, 66, 68, 70 are supported by the vehicle body 4.

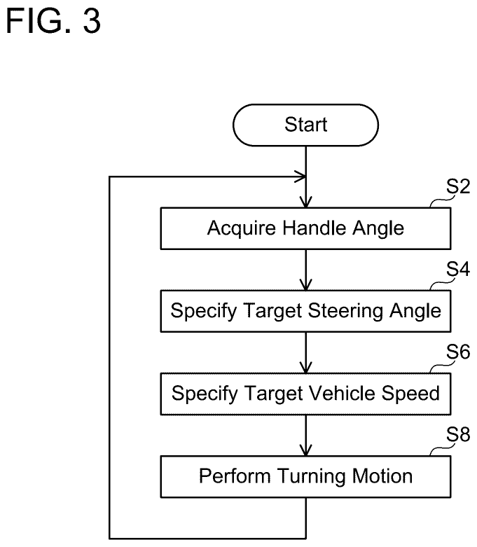

(Turning Motion Process) The control unit 52 executes a turning motion process shown in FIG. 3 when the main power of the cart 2 is on and the manual mode is selected.

In S2, the control unit 52 acquires a handle angle of the handle 8 via the handle angle sensor 32.

In S4, the control unit 52 determines a target steering angle for the right front wheel 10 and the left front wheel 12 based on the handle angle acquired in S2.

In S6, the control unit 52 determines a target vehicle speed for turning motion based on the handle angle acquired in S2.

In S8, the control unit 52 controls the steering motor 36 to actuate the steering mechanism 34 based on the target steering angle determined in S4 and further controls the right front wheel motor 24, the left front wheel motor 26, the right rear wheel motor 28, and the left rear wheel motor 30 to actuate the right front wheel 10, the left front wheel 12, the right rear wheel 14, and the left rear wheel 16 based on the target vehicle speed determined in S6. The cart 2 thus performs a turning motion with the right front wheel 10 and the left front wheel 12 angled at the target steering angle determined in S4 and the speed of the vehicle body 4 being at the target vehicle speed determined in S6. After S8, the process returns to S2.

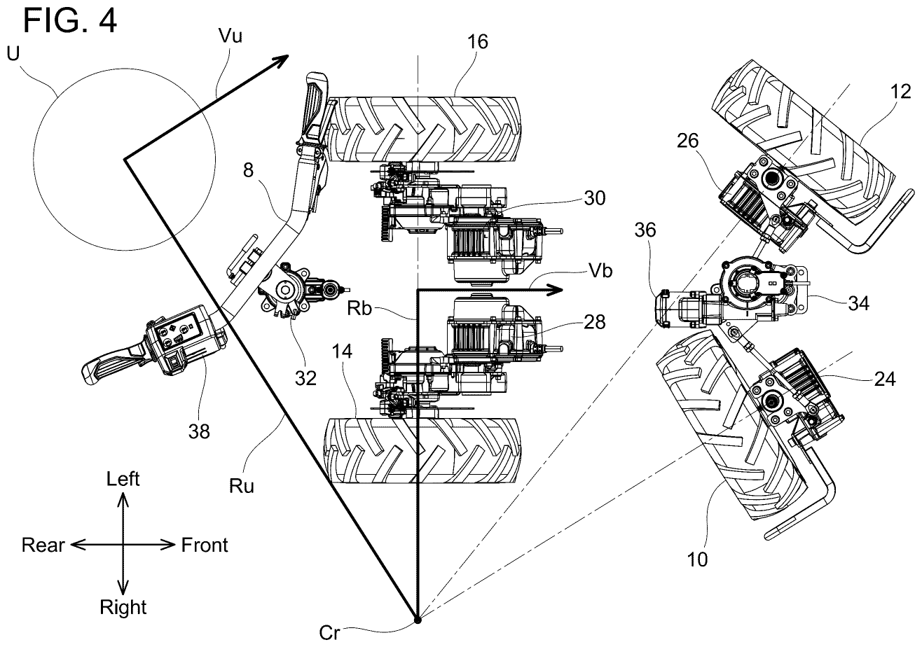

(Control on Vehicle Speed for Turning Motion) FIG. 4 shows a relationship between a vehicle speed Vb, which is the speed of the vehicle body 4, and a user speed Vu, which is the speed of a user U, during a turning motion by the cart 2. In the example shown in FIG. 4, the user U is rotating the handle 8 clockwise in the top view, and thus the cart 2 is performing a right-hand turning motion about a turning center Cr. In this case, a turning radius Ru of the user U is larger than a turning radius Rb of the vehicle body 4, and thus the user speed Vu is faster than the vehicle speed Vb during the turning motion. Specifically, the following relationship stands true: Vu=Vb×Ru/Rb. As FIG. 4 apparently shows, Ru/Rb takes a larger value with a smaller turning radius Rb of the vehicle body 4, whereas Ru/Rb takes a smaller value approaching a value “1” with a larger turning radius Rb of the vehicle body 4.

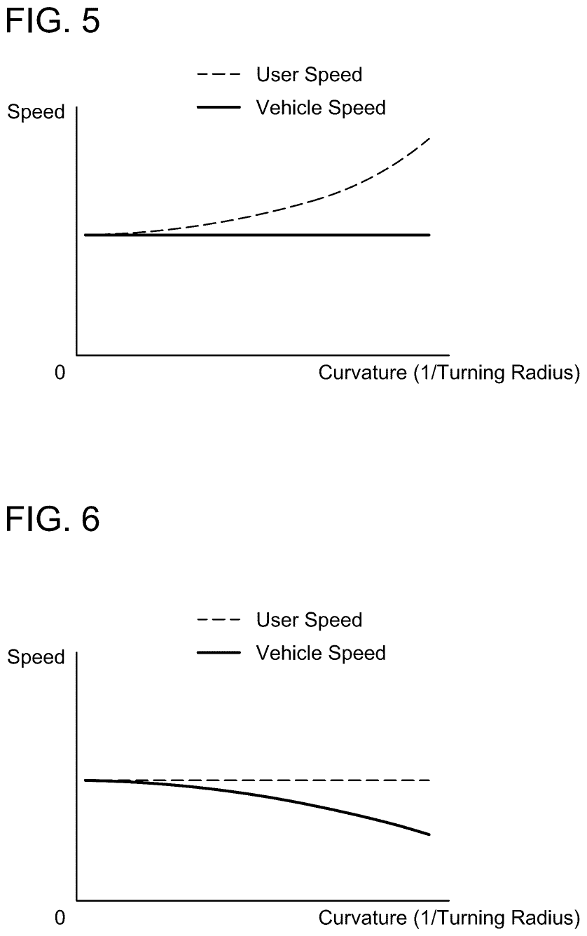

FIG. 5 shows an exemplary relationship between curvature of turning motion by the cart 2 (reciprocal of the turning radius Rb of the vehicle body 4), the vehicle speed Vb, and the user speed Vu. In the example shown in FIG. 5, the vehicle speed Vb is maintained constant regardless of the curvature of turning motion. In this case, the user speed Vu takes a value close to that of the vehicle speed Vb when the curvature of turning motion is small (i.e., the turning radius Rb is large), whereas the user speed Vu takes a value larger than that of the vehicle speed Vb when the curvature of turning motion is large (i.e., the turning radius Rb is small). Thus, when the cart 2 performs a turning motion with a large curvature (i.e., with a small turning radius Rb), the user who is walking behind the vehicle body 4 gripping the handle 8 is pulled or swung by this turning motion.

FIG. 6 shows another exemplary relationship between curvature of turning motion by the cart 2, the vehicle speed Vb, and the user speed Vu. In the example shown in FIG. 6, the vehicle speed Vb is reduced as the curvature of turning motion increases (i.e., as the turning radius Rb decreases). In this case, the user speed Vu can be maintained constant regardless of the curvature of turning motion. Therefore, even when the cart 2 performs a turning motion with a large curvature (i.e., with a small turning radius Rb), the user who is walking behind the vehicle body 4 gripping the handle 8 is not pulled or swung.

In the cart 2 according to this embodiment, a larger handle angle of the handle 8 leads to a larger steering angle of the steered wheels set by the steering mechanism 34, thus a larger curvature of turning motion by the cart 2. Conversely, a smaller handle angle of the handle 8 leads to a smaller steering angle of the steered wheels set by the steering mechanism 34, thus a smaller curvature of turning motion by the cart 2. Therefore, even when the horizontal axes of the graphs in FIGS. 5 and 6 are replaced by handle angle or steering angle, the same relationship stands true between the vehicle speed Vb and the user speed Vu.

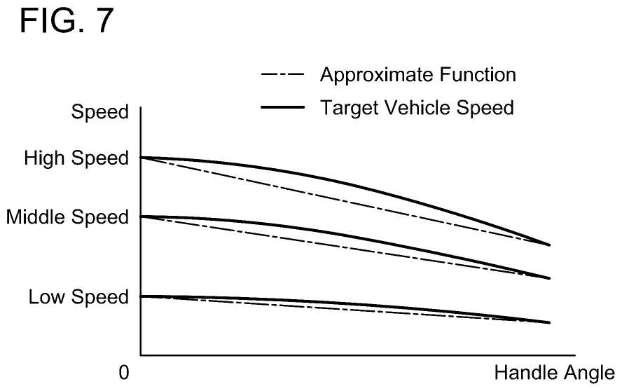

As shown in FIG. 7, in this embodiment, the control unit 52 calculates a target vehicle speed Vb as a function of the handle angle (see S6 in FIG. 3) in order to make the user speed Vu constant during a turning motion. FIG. 7 shows relationships between the handle angle and the target vehicle speed Vb for cases where the moving speed of the cart 2 is low, medium, and high, respectively, however, the same relationships stand true for speeds according to how much the trigger switch 44 is manipulated. In the example shown in FIG. 7, the smaller the handle angle is (i.e., the smaller the steering angle is/the smaller the curvature during turning motion is/the lager the turning radius of the vehicle body 4 is), the larger the target vehicle speed Vb during the turning motion is. Conversely, the larger the handle angle is (i.e., the larger the steering angle is/the larger the curvature during a turning motion is/the smaller the turning radius of the vehicle body 4 is), the smaller the target vehicle speed Vb during the turning motion is. By setting the target vehicle speed Vb in this way, it is possible to suppress the user, who is walking behind the vehicle body 4 gripping the handle 8 when the cart 2 turns, from being pulled or swung. In stead of calculating the target vehicle speed Vb as a function of the handle angle, the control unit 52 may calculate the target vehicle speed Vb as a function of the steering angle, calculate the target vehicle speed Vb as a function of the curvature of the turning motion, or calculate the target vehicle speed Vb as a function of the turning radius of the vehicle body 4 in S6 of FIG. 3.

As shown in FIG. 7, the target vehicle speed Vb to make the user speed Vu constant can be approximately calculated using a linear function of the handle angle (or a linear function of the steering angle or a linear function of the curvature of turning motion). Thus, in the cart 2 according to this embodiment, the control unit 52 calculates the target vehicle speed Vb using the linear function of the handle angle. For example, the target vehicle speed Vb is calculated by Vb=Vb0×(1−A× θ/θmax), where Vb0 is a vehicle speed when the cart 2 proceeds straight ahead, θ is a handle angle, θmax is the maximum handle angle (constant), and A is a positive constant. This configuration can reduce the processing load on the control unit 52.

The above has described how the control unit 52 controls the vehicle speed for turning motion while the cart 2 is moving forward, however, the control unit 52 may control the vehicle speed in the same way while the cart 2 is moving rearward.

(Variants) In the above embodiment, the right front wheel motor 24, the left front wheel motor 26, the right rear wheel motor 28, and the left rear wheel motor 30 may be in-wheel motors (not shown) incorporated in the right front wheel 10, the left front wheel 12, the right rear wheel 14, and the left rear wheel 16, respectively.

In the above embodiment, the right front wheel motor 24, the left front wheel motor 26, the right rear wheel motor 28, the left rear wheel motor 30, and the steering motor 36 may be brush DC motors, AC motors, or motors of other type.

In the above embodiment, the steering mechanism 34 may be actuated not by the steering motor 36 but by an actuator of other type.

In the above embodiment, the right front wheel 10, the left front wheel 12, the right rear wheel 14, and/or the left rear wheel 16 may be driven not by the right front wheel motor 24, the left front wheel motor 26, the right rear wheel motor 28, and the left rear wheel motor 30 but by an internal combustion engine.

In the above embodiment, electric power may be supplied to the cart 2 not from the battery pack 22 but from a power supply located external to the cart 2 through a power cable.

As above, in one or more embodiments, the cart 2 comprises the vehicle body 4; the right front wheel 10, the left front wheel 12, the right rear wheel 14, and the left rear wheel 16 (example of wheels) supported by the vehicle body and configured to be in contact with the ground; the right front wheel motor 24, the left front wheel motor 26, the right rear wheel motor 28, and the left rear wheel motor 30 (examples of prime mover) configured to drive the right front wheel 10, the left front wheel 12, the right rear wheel 14, and the left rear wheel 16; the handle 8 configured to be gripped by the user walking behind the vehicle body 4; and the control unit 52 configured to control operations of the right front wheel motor 24, the left front wheel motor 26, the right rear wheel motor 28, and the left rear wheel motor 30. When the cart 2 performs a turning motion, as compared to a target vehicle speed for a turning motion in which the turning radius of the vehicle body is large, the control unit 52 sets a slower target vehicle speed for a turning motion in which the turning radius of the vehicle body is small.

The configuration above allows the speed of the vehicle body 4 to be reduced for a turning motion in which the turning radius of the vehicle body 4 is smaller. This suppresses an increase in the user's speed when the cart 2 performs the turning motion. Thus, it is possible to suppress the user from being pulled or swung when the cart 2 performs the turning motion.

In one or more embodiments, the cart 2 further comprises the steering mechanism 34 configured to steer the right front wheel 10 and the left front wheel 12 as steered wheels.

The cart 2 with the steering mechanism 34 may be more likely to pull or swing the user when performing a turning motion, because it may perform the turn motion without reducing the speed of the vehicle body 4 sufficiently. The configuration above suppresses the user from being pulled or swung when the cart 2 comprising the steering mechanism 34 performs a turning motion.

In one or more embodiments, the handle 8 is supported by the vehicle body 4 so as to be rotatable about the rotation axis and configured to be rotated by the user. The cart 2 further comprises the handle angle sensor 32 configured to detect a rotation angle of the handle 8 about the rotation axis as a handle angle. The control unit 52 is configured to set a target steering angle of the steered wheels for turning motion based on the handle angle. The control unit 52 is configured to set the target vehicle speed for turning motion based on the handle angle.

When the cart 2 performs a turning motion according to the rotation of the handle 8 performed by the user, the larger the handle angle is, the smaller the turning radius of the vehicle body 4 is, whereas the smaller the handle angle is, the larger the turning radius of the vehicle body 4 is. The configuration above allows a slower target vehicle speed to be set for turning motion in which the turning radius of the vehicle body 4 is small than a target vehicle speed for turning motion in which the turning radius of the vehicle body 4 is large, with a simple structure.

In one or more embodiments, the control unit 52 is configured to calculate the target vehicle speed as a linear function of the handle angle.

The configuration above allows for a reduction in a processing load on the control unit 52.

In one or more embodiments, the right front wheel motor 24, the left front wheel motor 26, the right rear wheel motor 28, and the left rear wheel motor 30 correspond to the right front wheel 10, the left front wheel 12, the right rear wheel 14, and the left rear wheel 16, respectively.

The configuration above allows the speed of the vehicle body 4 to be easily adjusted when the cart 2 performs a turning motion.

What is claimed is:

1. A cart comprising:
a vehicle body;
wheels supported by the vehicle body and configured to be in contact with a ground;
a prime mover configured to drive the wheels;
a handle configured to be gripped by a user walking behind the vehicle body; and
a control unit configured to control an operation of the prime mover,
wherein
when the cart performs a turning motion, as compared to a target vehicle speed for a turning motion in which a turning radius of the vehicle body is large, the control unit is configured to set a slower target vehicle speed for a turning motion in which a turning radius of the vehicle body is small.

2. The cart according to claim 1, further comprising a steering mechanism configured to steer at least one of the wheels as a steered wheel.

3. The cart according to claim 2, wherein
the handle is supported by the vehicle body so as to be rotatable about a rotation axis and is configured to be rotated by the user,
the cart further comprises a handle angle sensor configured to detect a rotation angle of the handle about the rotation axis as a handle angle,
the control unit is configured to set a target steering angle of the steered wheel for the turning motion based on the handle angle, and
the control unit is configured to set the target vehicle speed for the turning motion based on the handle angle.

4. The cart according to claim 3, wherein the control unit is configured to calculate the target vehicle speed as a linear function of the handle angle.

5. The cart according to claim 1, wherein the prime mover comprises a plurality of motors corresponding to the wheels, respectively.

6. The cart according to claim 1, further comprising a steering mechanism configured to steer at least one of the wheels as a steered wheel,
wherein the handle is supported by the vehicle body so as to be rotatable about a rotation axis and is configured to be rotated by the user,
the cart further comprises a handle angle sensor configured to detect a rotation angle of the handle about the rotation axis as a handle angle,
the control unit is configured to set a target steering angle of the steered wheel for the turning motion based on the handle angle,
the control unit is configured to set the target vehicle speed for the turning motion based on the handle angle,
the control unit is configured to calculate the target vehicle speed as a linear function of the handle angle, and
the prime mover comprises a plurality of motors corresponding to the wheels, respectively.
